(19) United States
(12) Patent Application Publication
(10) Pub. No.: US 2019/0107905 A1
(43) Pub. Date: Apr. 11, 2019

(54) TOUCH PANEL

(71) Applicant: Sharp Kabushiki Kaisha, Osaka (JP)

(72) Inventors: Takenori MARUYAMA, Sakai City (JP); Kazutoshi KIDA, Sakai City (JP); Shinji YAMAGISHI, Sakai City (JP); Jean MUGIRANEZA, Sakai City (JP); Yukio MIZUNO, Sakai City (JP); Yasuhiro SUGITA, Sakai City (JP); Hiroshi FUKUSHIMA, Sakai City (JP); Hidetsugu KAWAMORI, Sakai City (JP)

(21) Appl. No.: 16/143,513

(22) Filed: Sep. 27, 2018

(30) Foreign Application Priority Data
Oct. 10, 2017 (JP) 2017-197268

(51) Int. Cl. G06F 3/047

(52) U.S. Cl. CPC G06F 3/047; G06F 2203/04111

(57) ABSTRACT

A touch panel includes electrode sections in an electrode layer and mainly includes electric wire sections in a bridge layer. The electrode sections are arranged in unit lattices alternately provided in the touch panel, and the electric wire sections are alternately arranged in unit lattices in which the electrode sections are not arranged. The electrode sections and the electric wire sections are electrically connected by connection sections penetrating through an insulating layer.

### BACKGROUND

### 1. Field

The present disclosure relates to a touch panel.

### 2. Description of the Related Art

Touch panels are widely adopted as input apparatuses for portable electronic products such as smartphones and tablet apparatuses. Such a touch panel is known as a touch panel as illustrated in FIGS. 7A to 9 (for example, see International Publication No. WO 2015/093581 published on Jun. 25, 2015). The touch panel generally includes two types of electrodes arranged in X and Y directions and is configured to detect a conductive element such as a finger and a non-conductive element such as an eraser based on combination of signals from the electrodes.

FIG. 7A is a view schematically illustrating an example of an arrangement of electrode sections in an electrode layer of a related art touch panel. FIG. 7B is a view schematically illustrating an arrangement of first electrodes and second electrodes in the electrode layer of the related art touch panel. FIG. 7C is a view schematically illustrating an arrangement of third electrodes and fourth electrodes in the electrode layer of the related art touch panel.

Moreover, FIG. 8A is a view schematically illustrating an example of an arrangement of electric wire sections in a bridge layer of the related art touch panel. FIG. 8B is a view schematically illustrating an example of a connection topology of the electrode layer and the bridge layer of the related art touch panel.

The related art touch panel includes, for example, the electrode layer, an insulating layer, and the bridge layer stacked in this order. The touch panel includes first electrodes 51 and second electrodes 52 which are successive in the X direction, and third electrodes 53 and fourth electrodes 54 which are successive in the Y direction orthogonal to the X direction (FIG. 7A). These electrodes are electrically independent of each other.

Moreover, the touch panel includes unit lattices A and unit lattices B alternately arranged one by one in the X direction, and unit lattices C and unit lattices D alternately arranged one by one in the Y direction orthogonal to the X direction.

Each first electrode 51 includes: a first electrode section disposed in the electrode layer in a corresponding one of the unit lattices A; and a first electric wire section disposed in the electrode layer in a corresponding one of the unit lattices B and connecting the first electrode sections to each other in the X direction. Each second electrode 52 includes: a second electrode section disposed in the electrode layer in a corresponding one of the unit lattices B; and a second electric wire section disposed in the electrode layer in a corresponding one of the unit lattices A and connecting the second electrode sections to each other in the X direction. The first electric wire section is disposed on one side in the Y direction, and the second electric wire section is disposed on the other side in the Y direction.

The first electrode section has a shape formed by connecting top corners of two triangles facing each other by a linear part. On one side in the Y direction of the unit lattice in which the first electrode section is disposed, the second electric wire section is disposed. Thus, the triangle of the first electrode section on the one side is smaller than the triangle of the first electrode section on the other side (FIG. 7B).

The second electrode 52 has a similar configuration to the first electrode 51. Thus, also in the second electrode section, the triangle of the second electrode section on the other side is smaller than the triangle of the second electrode section on the one side.

The third electrode 53 and the fourth electrode 54 have configurations similar to the configurations of the first electrode 51 and the second electrode 52 respectively except that they extend in the Y direction. For example, a third electrode section of the third electrode 53 also has a shape formed by connecting top corners of two triangles facing each other by a linear part, and a fourth electric wire section is disposed on one side in the X direction of a unit lattice. Thus, the triangle of the third electrode section on the one side is smaller than the triangle of the third electrode section on the other side. Similarly, a triangle of a fourth electrode section of the fourth electrode 54 on the other side is smaller than a triangle of the fourth electrode section on the one side due to a third electric wire section of the third electrode 53 (FIG. 7C).

At a location where the sections of the first electrode 51 to the fourth electrode 54 overlap each other, one of the sections of each electrode is disposed in the electrode layer, and the other of the sections of each electrode is connected with the insulating layer being bypassed to the bridge layer. For example, as illustrated in FIG. 8B, the fourth electric wire section of the fourth electrode 54 extending in the Y direction crosses the second electric wire section of the second electrode 52 extending in the X direction. At the sections which crosses each other, a fourth electrode layer of the fourth electrode 54 includes connection sections 60 including a conductive material filled in pores penetrating the insulating layer and a bridge section 54B which electrically connects the connection sections 60 in pairs to each other, and the second electric wire section is sandwiched between the connection sections 60. The bridge section 54B is disposed on the bridge layer.

In the bridge layer at the location where the electrodes cross each other, as illustrated in FIG. 8A, bridge sections 51B, 52B, 53B, and 54B corresponding to the first to fourth electrodes respectively are arranged. Moreover, in the insulating layer, the connection sections are formed correspondingly to the respective bridge sections.

FIG. 9 is a view schematically illustrating the magnitude of electrical capacity of each electrode section in a unit lattice of the related art touch panel. In the touch panel, one of the two triangles constituting each electrode section described above is small because of the electric wire section provided to other electrode. When the size of the electrode section is reduced, the intensity of the electrical signal tends to be reduced.

Thus, in the related art touch panel, the intensity of the electrical signal of the electrode section is high in an area having high electrical capacity (for example, in the area surrounded by the broken line A in FIG. 9) and is low in an area having low electrical capacity (for example, in the area surrounded by the broken line B in FIG. 9) as illustrated in FIG. 9. Thus, in the related art touch panel, deviation in signal intensity may be caused due to the difference of the size of the electrode sections.

### SUMMARY

An aspect of the present disclosure is to realize a touch panel capable of reducing deviation in signal intensity caused due to the difference of the size of electrode sections.

A touch panel according to one aspect of the present disclosure includes: an electrode layer, an insulating layer, and a bridge layer which are sequentially stacked on one another; first electrodes and second electrodes successively and electrically independently arranged in each of the electrode layer and the bridge layer in an X direction; and unit lattices A and unit lattices B alternately arranged one by one in the X direction. Each of the first electrodes includes: a first electrode section disposed in the electrode layer in a corresponding one of the unit lattices A; a first electric wire section disposed in at least the bridge layer in a corresponding one of the unit lattices B and connecting the first electrode sections to each other in the X direction; and a first connection section penetrating through the insulating layer and electrically connecting a section of the first electrode in the electrode layer to the first electric wire section in the bridge layer. Each of the second electrodes includes: a second electrode section disposed in the electrode layer in a corresponding one of the unit lattices B; a second electric wire section disposed in at least the bridge layer in a corresponding one of the unit lattices A and connecting the second electrode sections to each other in the X direction; and a second connection section penetrating through the insulating layer and electrically connecting a section of the second electrode in the electrode layer to the second electric wire section in the bridge layer.

### BRIEF DESCRIPTION OF THE DRAWINGS

FIG. 1A is a view schematically illustrating a layer structure of a touch panel according to a first embodiment of the present disclosure, and FIG. 1B is a view schematically illustrating a planar structure of an electrode layer of the first embodiment;

FIG. 2 is a view schematically illustrating a connection topology of electrode sections, electric wire sections, and connection sections of the first embodiment;

FIG. 3 is a view schematically illustrating the magnitude of electrical capacity of the electrode section in a unit lattice of the touch panel according to the first embodiment;

FIG. 4A is a view schematically illustrating a layer structure of a touch panel according to a second embodiment of the present disclosure, FIG. 4B is a view schematically illustrating an example of a visual effect in the touch panel of the second embodiment, and FIG. 4C is a view schematically illustrating an example of a visual effect in the touch panel of the first embodiment;

FIG. 5A is a view schematically illustrating a layer structure of a touch panel according to a third embodiment of the present disclosure, and FIG. 5B is a view schematically illustrating a layer structure of a touch panel according to a fourth embodiment of the present disclosure;

FIG. 6A is a view schematically illustrating a structure of a part of the electrode layer of the touch panel according to the third embodiment of the present disclosure, FIG. 6B is a view schematically illustrating a structure of a part of electrode sections in FIG. 6A disposed in a first electrode layer, and FIG. 6C is a view schematically illustrating a structure of a part of the electrode sections in FIG. 6A disposed in a second electrode layer;

FIG. 7A is a view schematically illustrating an example of an arrangement of electrode sections in an electrode layer of a related art touch panel, FIG. 7B is a view schematically illustrating an arrangement of first electrodes and second electrodes in the electrode layer of the related art touch panel, and FIG. 7C is a view schematically illustrating an arrangement of third electrodes and fourth electrodes in the electrode layer of the related art touch panel;

FIG. 8A is a view schematically illustrating an example of an arrangement of electric wire section in a bridge layer of the related art touch panel, and FIG. 8B is a view schematically illustrating an example of a connection topology of the electrode layer and the bridge layer of the related art touch panel; and

FIG. 9 is a view schematically illustrating the magnitude of electrical capacity of each electrode section in a unit lattice of the related art touch panel.

### DESCRIPTION OF THE EMBODIMENTS

### First Embodiment

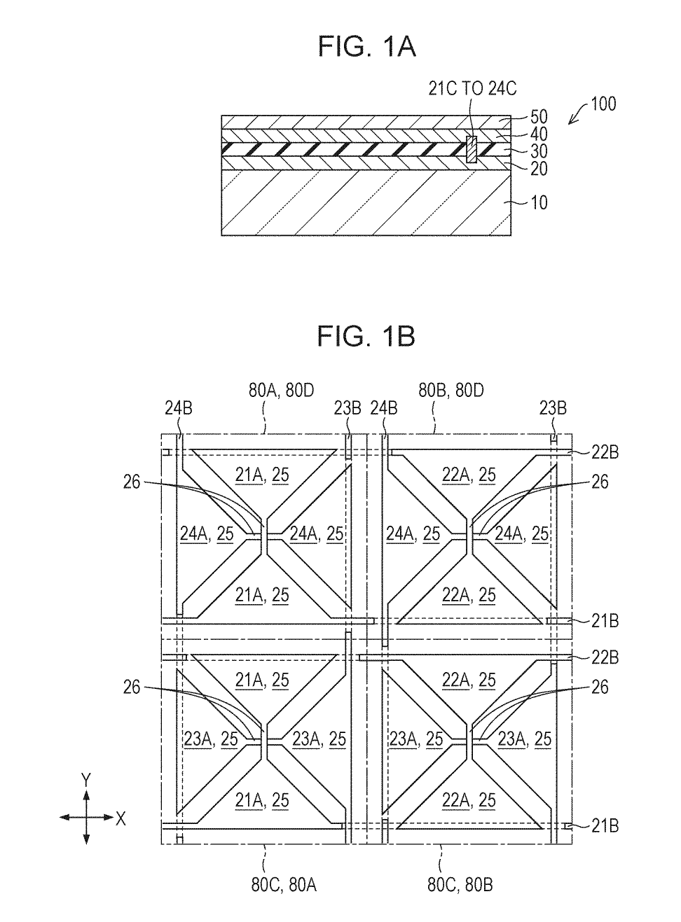

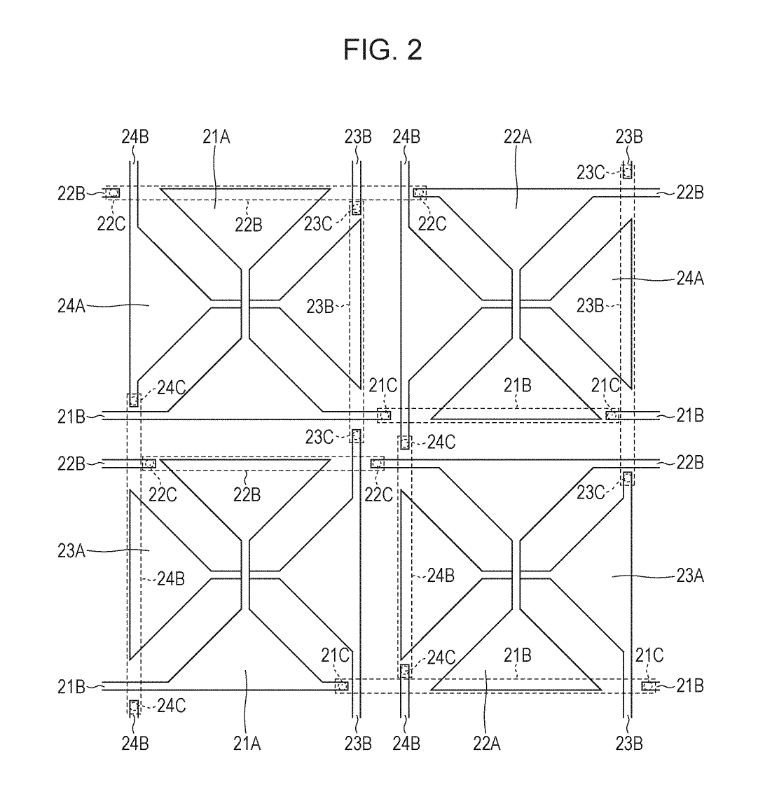

An embodiment of the present disclosure will be described in detail below. FIG. 1A is a view schematically illustrating a layer structure of a touch panel according to a first embodiment of the present disclosure, and FIG. 1B is a view schematically illustrating a planar structure of an electrode layer of the first embodiment. FIG. 2 is a view schematically illustrating a connection topology of electrode sections, electric wire sections, and connection sections of the first embodiment.

As illustrated in FIG. 1A, a touch panel 100 includes a substrate 10, an electrode layer 20, an insulating layer 30, a bridge layer 40, and a protection layer 50. These layers are stacked on the substrate 10 in the above-described order. The touch panel 100 further includes connection sections (a first connection section 21C to a fourth connection section 24C) penetrating through the insulating layer 30 and electrically connecting the electrode layer 20 and the bridge layer 40 to each other.

The substrate 10, the electrode layer 20, the insulating layer 30, the bridge layer 40, and the protection layer 50 may be configured in a manner similar to a known technique except for the arrangement of electrodes described below. The substrate and these layers may be fabricated in a similar manner to and made of the same material as those in International Publication No. WO 2015/093581 (publication date: Jun. 25, 2015) except for the arrangement of the electrodes described below. Examples of the substrate 10 include a glass substrate. Examples of the material for the electrode layer 20 and the bridge layer 40 include a conductive material which will be described later. Examples of the insulating layer 30 include an organic insulating film (JAS). Examples of the protection layer 50 include a SiO₂ film.

The touch panel 100 includes first electrodes 21 and second electrodes 22 which are successively and electrically independently arranged in an X direction. The touch panel 100 includes unit lattices 80A and unit lattices 80B alternately arranged one by one in the X direction. The touch panel 100 further includes third electrodes 23 and fourth electrodes 24 which are successively arranged in a Y direction orthogonal to the X direction. The touch panel 100 includes unit lattices 80C and unit lattices 80D alternately arranged one by one in the Y direction.

The unit lattices 80A, 80B, 80C, and 80D are square regions partitioning the electrode layer 20 and having the same area. Of these unit lattices, the unit lattices 80A, 80B, 80A, 80B, . . . are alternately arranged in the X direction, and the unit lattices 80C, 80D, 80C, 80D, . . . are alternately arranged in the Y direction. Each unit lattice 80A overlaps a corresponding one of the unit lattices 80C or a corresponding one of the unit lattices 80D, and each unit lattice 80B overlaps a corresponding one of the unit lattices 80C or a corresponding one of the unit lattices 80D.

The first electrodes 21, the second electrodes 22, the third electrodes 23, and the fourth electrodes 24 are each made of a conductive material. The conductive material of each electrode may include one or more types of conductive materials. Examples of such conductive materials include metal such as Cu and Ag and transparent conductive materials such as indium tin oxide (ITO) and indium zinc oxide (IZO).

Each first electrode 21 includes a first electrode section 21A, a first electric wire section 21B, and a first connection section 21C.

The first electrode section 21A is disposed in the electrode layer 20 in the unit lattice 80A. A further detailed configuration of the first electrode section 21A will be described later.

The first electric wire sections 21B are alternately arranged in the electrode layer 20 and the bridge layer 40 and altogether form a conductive section extending in the X direction. The first electric wire sections 21B are arranged on one side (in the lower part on the drawing sheet) in the Y direction of the unit lattices. Each first electric wire section 21B is disposed mainly in the electrode layer 20 in the unit lattice 80A and is connected to the first electrode section 21A. Each first electric wire section 21B is disposed mainly in the bridge layer 40 in the unit lattice 80B and is electrically connected to the first electric wire section 21B in the electrode layer 20 by the first connection section 21C. As described above, the first electric wire section 21B is disposed in at least the bridge layer 40 in the unit lattice 80B and connects the first electrode sections 21A in the X direction.

The first connection section 21C penetrates through the insulating layer 30 and electrically connects a section (for example, the first electric wire section 21B) of the first electrode 21 in the electrode layer 20 and the first electric wire section 21B in the bridge layer 40 to each other.

The second electrodes 22, the third electrodes 23, and the fourth electrodes 24 are configured in a similar manner to the first electrodes 21 except for the direction in which the electrodes extend and the unit lattices in which the electrodes are arranged. That is, each second electrode 22 includes a second electrode section 22A, a second electric wire section 22B, and a second connection section 22C. Each third electrode 23 includes a third electrode section 23A, a third electric wire section 23B, and a third connection section 23C. Each fourth electrode 24 includes a fourth electrode section 24A, a fourth electric wire section 24B, and a fourth connection section 24C.

The second electrode section 22A is disposed in the electrode layer 20 in the unit lattice 80B. The third electrode section 23A is disposed in the electrode layer 20 in the unit lattice 80C. The fourth electrode section 24A is disposed in the electrode layer 20 in the unit lattice 80D. Further detailed configurations of the second electrode section 22A, the third electrode section 23A, and the fourth electrode section 24A will be described later as in the case of the first electrode section 21A.

The second electric wire sections 22B are alternately arranged in the electrode layer 20 and the bridge layer 40. The third electric wire sections 23B are alternately arranged in the electrode layer 20 and the bridge layer 40. The fourth electric wire sections 24B are alternately arranged in the electrode layer 20 and the bridge layer 40. The second electric wire sections 22B altogether form a conductive section extending in the X direction and are arranged on the other side (in the upper part on the drawing sheet) in the Y direction of the unit lattices. The third electric wire sections 23B altogether form a conductive section extending in the Y direction and are arranged on one side (in the right part on the drawing sheet) in the X direction of the unit lattices. The fourth electric wire sections 24B altogether form a conductive section extending in the Y direction and are arranged on the other side (in the left part on the drawing sheet) in the X direction of the unit lattices.

Each second electric wire section 22B is disposed mainly in the electrode layer 20 in the unit lattice 80B and is connected to the second electrode section 22A. Each second electric wire section 22B is disposed mainly in the bridge layer 40 in the unit lattice 80A and is electrically connected to the second electric wire section 22B in the electrode layer 20 by the second connection section 22C.

Each third electric wire section 23B is disposed mainly in the electrode layer 20 in the unit lattice 80C and is connected to the third electrode section 23A. Each third electric wire section 23B is disposed mainly in the bridge layer 40 in the unit lattice 80D and is electrically connected to the third electric wire section 23B in the electrode layer 20 by the third connection section 23C.

Each fourth electric wire section 24B is disposed mainly in the electrode layer 20 in the unit lattice 80D and is connected to the fourth electrode section 24A. Each fourth electric wire section 24B is disposed mainly in the bridge layer 40 in the unit lattice 80C and is electrically connected to the fourth electric wire section 24B in the electrode layer 20 by the fourth connection section 24C.

As described above, the second electric wire section 22B is disposed in at least the bridge layer 40 in each unit lattice 80A and connects the second electrode sections 22A in the X direction. The third electric wire section 23B is disposed in the bridge layer 40 of in least the unit lattice 80D and connects the third electrode sections 23A in the Y direction. The fourth electric wire section 24B is disposed in at least the bridge layer 40 in the unit lattice 80C and connects the fourth electrode sections 24A in the Y direction.

The second connection section 22C penetrates through the insulating layer 30 and electrically connects a section (for example, the second electric wire section 22B) of the second electrode 22 in the electrode layer 20 and the second electric wire section 22B in the bridge layer 40 to each other. The third connection section 23C penetrates through the insulating layer 30 and electrically connects a section (for example, the third electric wire section 23B) of the third electrode 23 in the electrode layer 20 and the third electric wire section 23B in the bridge layer 40 to each other. The fourth connection section 24C penetrates through the insulating layer 30 and electrically connects a section (for example, the fourth electric wire section 24B) of the fourth electrode 24 in the electrode layer 20 and the fourth electric wire section 24B in the bridge layer 40 to each other.

Here, the configuration of the electrode section will be described in further detail. Each of the first electrode section 21A, the second electrode section 22A, the third electrode section 23A, and the fourth electrode section 24A includes two triangle sections 25 and a joint section 26. The two triangle sections 25 face each other. The joint section 26 has a linear shape and connects top corners of the triangle sections 25 to each other. The triangle sections 25 are arranged in two of four triangular areas defined by diagonals in each of the unit lattices 80A to 80D, the two triangular areas facing each other.

One of the two connection sections in a positional relationship in which the two connection sections cross each other at the center of the unit lattices 80A to 80D in plan view bypasses, in a similar manner to the first connection section 21C and the like, the insulating layer 30 to the bridge layer 40 to connect the triangle sections 25. For example, the joint sections 26 of the third electrode section 23A and the fourth electrode section 24A bypass the insulating layer 30 to the bridge layer 40 to connect the triangle sections 25 with respect to joint sections 26 of the first electrode section 21A and the second electrode section 22A.

The triangle section 25 of the first electrode section 21A has bottom corners to which the first electric wire section 21B is connected. The triangle section 25 of the second electrode section 22A has bottom corners to which the second electric wire section 22B is connected. The triangle section 25 of the third electrode section 23A has bottom corners to which the third electric wire section 23B is connected. The triangle section 25 of the fourth electrode section 24A has bottom corners to which the fourth electric wire section 24B is connected. Thus, the first electrode section 21A, the second electrode section 22A, the third electrode section 23A, and the fourth electrode section 24A have substantially the same area in a unit lattice.

Thus, in the electrode layer 20 of the touch panel 100, the electrode sections having the same shape are alternately arranged in both the X direction and the Y direction. The electric wire sections bypass the insulating layer 30 to the bridge layer 40 with respect to the electrode sections and the electric wire sections except for the electrode sections to be connected.

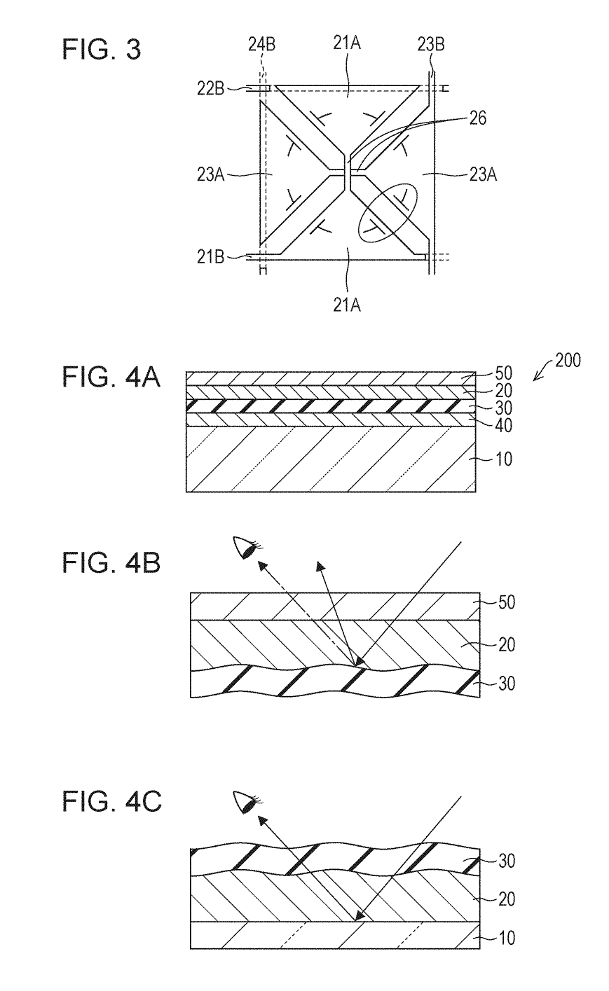

FIG. 3 is a view schematically illustrating the magnitude of electrical capacity of the electrode section in a unit lattice of the touch panel according to the first embodiment.

In the touch panel 100, the areas of the electrode sections arranged in the unit lattices are also substantially the same. Thus, the electrical capacity of the electrode section (the triangle section 25) is also uniform. This reduces the occurrence of deviation in the electrical capacity between the electrode sections adjacent to each other in an identical unit lattice (for example, in a part surrounded by the broken line extending to both the first electrode section 21A and the third electrode section 23A in FIG. 3). Thus, substantially no deviation in intensity between electrode sections occurs in the touch panel 100, and therefore, the linearity of the touch panel 100 (the linearity of a response to linear contact) is improved more than that of the related art touch panel.

Moreover, in the touch panel 100, the areas of the electrode sections are substantially the same, and therefore, the area of each electrode section in each unit lattice is larger and the intensity of the signal is higher than those of the related art touch panel. Furthermore, in the touch panel 100, the ratio of the area of the electrode sections (the triangle sections 25) made of ITO in each unit lattice is high, and sections which include no electrode sections made of ITO and whose density is thus different from that of the electrode sections made of ITO are sufficiently smaller than the electrode sections made of ITO. Thus, in the touch panel 100, the viewability at wiring sections is improved more than in the related art touch panel.

### Second Embodiment

Other embodiments of the present disclosure will be described below. Note that for the sake of description, in each of the following embodiments, members having the same functions as those described in the above-described embodiment are denoted by the same reference numbers, and the description thereof will be omitted.

FIG. 4A is a view schematically illustrating a layer structure of a touch panel according to a second embodiment of the present disclosure. FIG. 4B is a view schematically illustrating an example of a visual effect in the touch panel of the second embodiment. FIG. 4C is a view schematically illustrating an example of a visual effect in the touch panel of the first embodiment.

In a touch panel 200, as illustrated in FIG. 4A, a bridge layer 40, an insulating layer 30, an electrode layer 20, and a protection layer 50 are stacked in this order on a substrate 10. The touch panel 200 is configured in a similar manner to the touch panel 100 except the layer structure. For example, the substrate 10 is a glass substrate, an electrode material for the bridge layer 40 and the electrode layer 20 is ITO, the insulating layer 30 is an organic insulating film (JAS), and the protection layer 50 is a silica layer.

The touch panel 200 provides effects similar to those provided by the touch panel 100 and, in addition, provides the following effects. The organic insulating film as the insulating layer 30 generally has an uneven surface as illustrated in FIG. 4B. The touch panel 200 includes the electrode layer 20 on the insulating layer 30. Thus, in the touch panel 200, a diffused reflection is more likely to occur at the interface between the electrode layer 20 and the insulating layer 30. Thus, a specular reflection (which is, for example, indicated by the long dashed short dashed line arrow in FIG. 4B) is less likely to occur at the interface of the insulating layer 30. Thus, the pattern of a first electrode 21 to a fourth electrode 24 in the electrode layer 20 is less visible.

In contrast, in the touch panel 100, as illustrated in FIG. 4C, a specular reflection of light passing through the electrode layer 20 is more likely to occur at the interface of the substrate 10 with respect to the electrode layer 20. Thus, in the touch panel 100, the pattern formed by the electrodes in the electrode layer 20 is more likely to be visible than in the touch panel 200.

### Third Embodiment

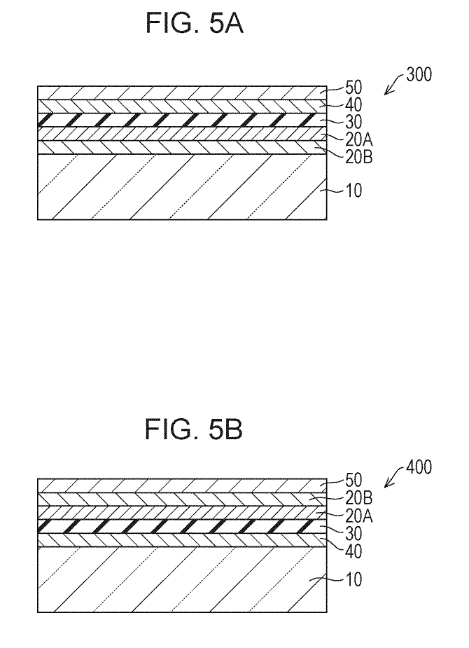

Other embodiments of the present disclosure will be described below. Note that for the sake of description, in each of the following embodiments, members having the same functions as those described in the above-described embodiments are denoted by the same reference numbers, and the description thereof will be omitted. FIG. 5A is a view schematically illustrating a layer structure of a touch panel according to a third embodiment of the present disclosure.

In a touch panel 300, as illustrated in FIG. 5A, a second electrode layer 20B, a first electrode layer 20A, an insulating layer 30, a bridge layer 40, and a protection layer 50 are stacked in this order on a substrate 10. Thus, the touch panel 300 has the same configuration as the touch panel 100 except for the first electrode layer 20A and the second electrode layer 20B provided in place of the electrode layer 20.

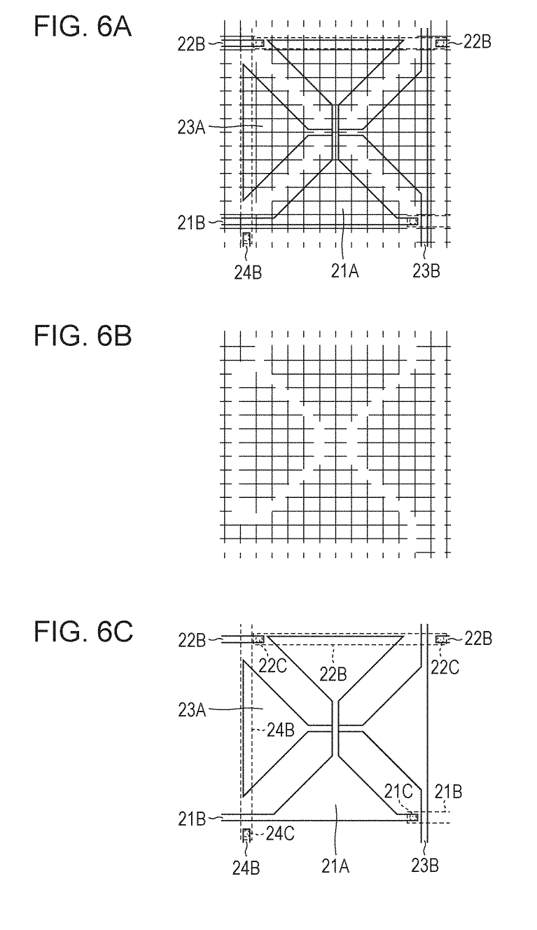

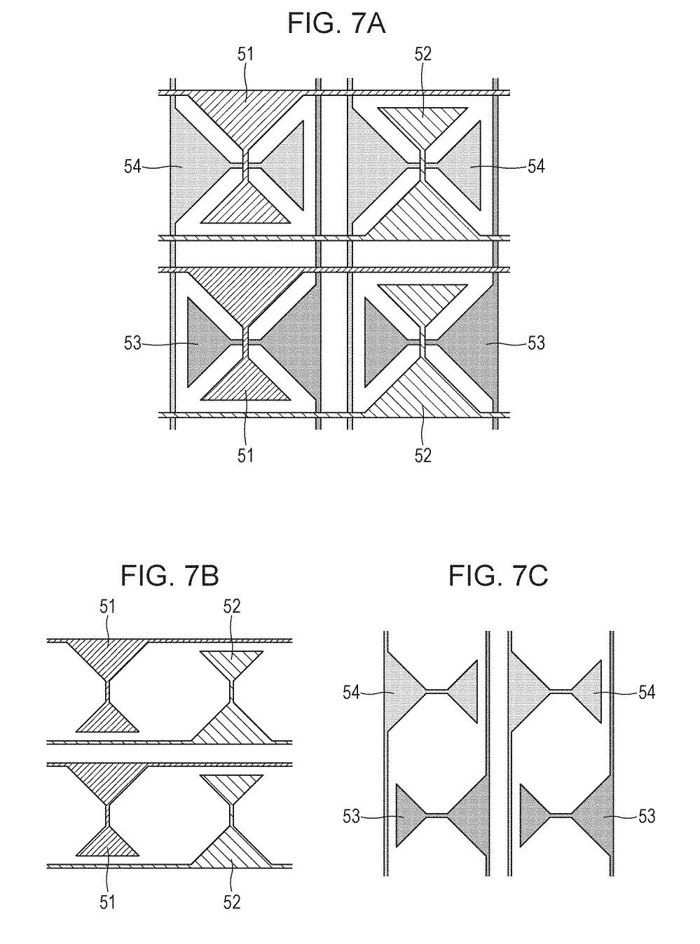

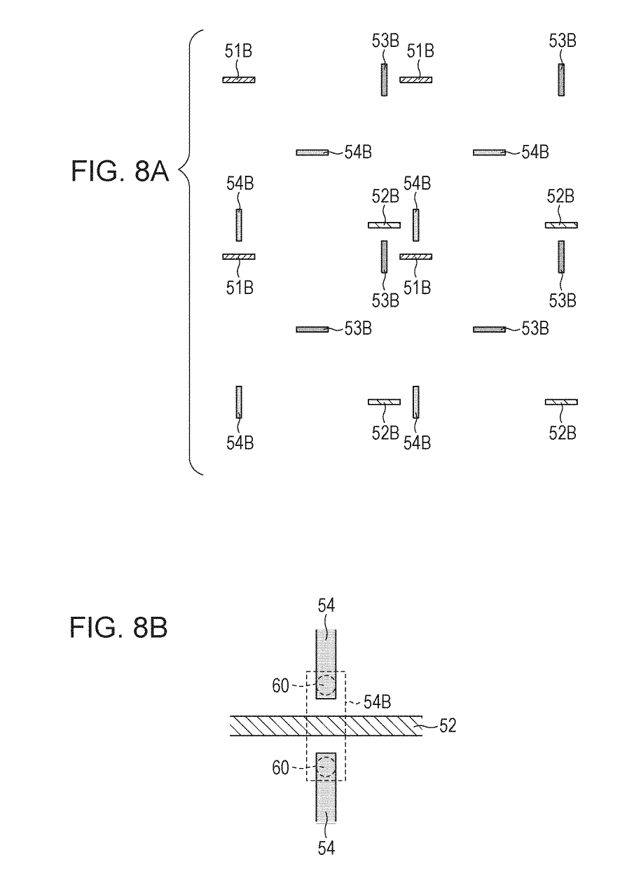

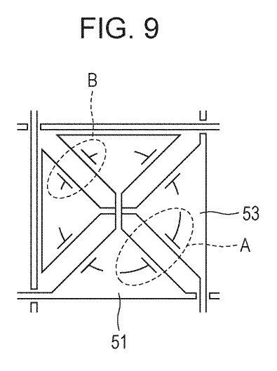

In one of the first electrode layer 20A and the second electrode layer 20B, parts of a first electrode section 21A, a second electrode section 22A, a third electrode section 23A, and a fourth electrode section 24A are formed, and in the other of the first electrode layer 20A and the second electrode layer 20B, remaining parts of the first electrode section 21A, the second electrode section 22A, the third electrode section 23A, and the fourth electrode section 24A are formed. FIG. 6A is a view schematically illustrating a structure of a part of the electrode layer of the touch panel according to the third embodiment of the present disclosure. FIG. 6B is a view schematically illustrating a structure of a part of electrode sections in FIG. 6A disposed in a first electrode layer. FIG. 6C is a view schematically illustrating a structure of a part of the electrode sections in FIG. 6A disposed in a second electrode layer.

As illustrated in FIG. 6A, parts of the electrode sections made of ITO and the electric wire sections and a lattice-like electrode made of copper and overlapping the parts are formed in the electrode layer of the touch panel 300.

More specifically, as illustrated in FIG. 6B, a lattice-like electrode formed of extra-fine copper wires is disposed in the second electrode layer 20B. The copper wires which are included in the lattice-like electrode and which do not overlap the electrode sections and the electric wire sections in the first electrode layer 20A are cut or removed. Thus, the lattice-like electrode is located to overlap the electrode sections and the electric wire sections in the first electrode layer 20A and is disposed in the second electrode layer 20B to have a form maintaining prescribed electrical independence of these sections.

In the first electrode layer 20A, as illustrated in FIG. 6C, parts of the electrode sections made of ITO and the electric wire sections are arranged. The arrangement of the parts of the electrode sections made of ITO and the electric wire sections in the first electrode layer 20A is the same as that in the electrode layer 20 of the touch panel 100 of the first embodiment. The electrode sections made of ITO in the first electrode layer 20A overlap and are in contact with the lattice-like electrode in the second electrode layer 20B in the lamination direction.

That is, in the electrode layer of the touch panel 300 are arranged the electrode sections and the electric wire sections including: parts made of ITO and being in an electrically independent positional relationship; and the lattice-like electrode formed of fine wires made of copper and lining the parts.

In the bridge layer of the touch panel 300, remaining parts of the electric wire sections are formed in a similar manner to the first embodiment and are connected to the electric wire sections in the first electrode layer 20A and the second electrode layer 20B by connection sections. Moreover, one of the joint sections in a positional relationship in which the electrode sections cross each other also bypasses the insulating layer to the bridge layer in a similar manner to the first embodiment.

Thus, in each unit lattice of the touch panel 300, electrodes made of a conductive material having transparency and an electrode made of metal and having a transparent structure, namely, a lattice formed of fine wires are arranged.

Here, when the electrical resistance of copper and the electrical resistance of ITO are compared with each other, the electrical resistance value of copper is sufficiently lower than that of ITO. Thus, when an electrode made of copper and an electrode made of ITO which have the same shape are compared with each other, the electrical resistance value of the electrode made of copper is sufficiently lower than that of the electrode made of ITO.

In general, in a touch panel, a low electrical resistance value of the electrode means that the charging time of the electrode section is short. Thus, forming the first electrode layer 20A and the second electrode layer 20B, as previously described, to include electrodes made of ITO and electrodes made of metal overlapping the electrodes made of ITO significantly reduces the charging time of the electrode sections, for example, to about ⅓ of that of the case where the electrodes are made of only ITO.

Thus, the touch panel 300 provides similar effects to the touch panel 100, reduces the charging time as compared to the touch panel 100, and therefore, the touch panel 300 further provides the effect of further improving the functions of the touch panel (for example, the speed of response).

Moreover, in the touch panel 300, the charging time is shorter than that in the touch panel made of ITO. Thus, according to the present embodiment, it is possible to configure a touch panel whose transparency is as sufficient as that of the related art touch panel and whose size is larger than that of the related art touch panel.

### Fourth Embodiment

Other embodiments of the present disclosure will be described below. Note that for the sake of description, in each of the following embodiments, members having the same functions as those described in the above-described embodiments are denoted by the same reference numbers, and the description thereof will be omitted. FIG. 5B is a view schematically illustrating a layer structure of a touch panel according to a fourth embodiment of the present disclosure.

In a touch panel 400, as illustrated in FIG. 5B, a bridge layer 40, an insulating layer, a first electrode layer 20A, a second electrode layer 20B, and a protection layer 50 are stacked in this order on a substrate 10. That is, the touch panel 400 has the same configuration as the touch panel 200 except for the first electrode layer 20A and the second electrode layer 20B provided in place of the electrode layer 20.

The touch panel 400 provides both the effect provided by the touch panel 200 and the effect provided by the touch panel 300.

### Variations

In the above-described touch panel, two types of electrodes are alternately arranged along both the X direction and the Y direction. The electrodes may be alternately arranged along only one of the X direction and the Y direction. In this case, a touch panel which provides the above-described effect in the operation by contact in one direction is configured.

In the above-described embodiment, the electrode sections in the unit lattice in plan view mainly have a triangular shape, but the shape of the electrode sections in the unit lattice in plan view may be other shapes such as a rectangular shape, a round shape, and a non-round shape.

In the present embodiment, the electrodes extend in two directions, namely, the X direction and the Y direction, but the electrodes may extend in more than two directions. For example, the electrodes may extend in three directions, namely, V, W, and X directions which cross one another at an angle of 60°.

Moreover, in the present embodiment, a structure in which the electrode layer is a single layer and a structure in which the electrode layer includes two layers have been described, but the electrode layer may include more than two layers. For example, the electrode layer may include four electrode layers, namely, first to fourth electrode layers in which first to fourth electrodes are respectively arranged.

In the third and fourth embodiments, the electrodes made of ITO are uniformly formed in their overall shape (so-called solid electrodes), but the electrodes made of ITO may be a collection of a plurality of ITO layer pieces electrically connected to each other by the lattice-like electrode.

Alternatively, in the third and fourth embodiments, the copper wires of the lattice-like electrode are linearly arranged but may be arranged in other forms. For example, the copper wires may be arranged in a form appropriate to increase viewability (transparency) in each unit lattice.

Moreover, when the touch panel of the present embodiment includes a plurality of electrode layers, an additional insulating layer such as an organic insulating film may be further provided between the electrode layers. In this case, contact sections for electrically connecting the electrode layers insulated by the additional insulating layer may accordingly be arranged. For example, when an additional insulating layer is disposed between the first electrode layer 20A and the second electrode layer 20B in the touch panel 300, contact sections for electrically connecting these electrode layers are further formed. The contact sections in this case electrically connect each electrode section in the first electrode layer 20A to a corresponding one of the electric wire sections in the second electrode layer 20B. The number of the contact sections may accordingly be determined within a range which enables the electrode sections and the electric wire sections to be sufficiently electrically connected. The contact sections may be made of a conductive material in a similar manner to the above-described connection sections.

### SUMMARY

A touch panel according to a first aspect of the present disclosure includes: an electrode layer, an insulating layer, and a bridge layer which are sequentially stacked on one another; first electrodes and second electrodes successively and electrically independently arranged in each of the electrode layer and the bridge layer in an X direction; and unit lattices A and unit lattices B alternately arranged one by one in the X direction. Each of the first electrodes includes: a first electrode section disposed in the electrode layer in a corresponding one of the unit lattices A; a first electric wire section disposed in at least the bridge layer in a corresponding one of the unit lattices B and connecting the first electrode sections to each other in the X direction; and a first connection section penetrating through the insulating layer and electrically connecting a section of the first electrode in the electrode layer to the first electric wire section in the bridge layer. Each of the second electrodes includes: a second electrode section disposed in the electrode layer in a corresponding one of the unit lattices B; a second electric wire section disposed in at least the bridge layer in a corresponding one of the unit lattices A and connecting the second electrode sections to each other in the X direction; and a second connection section penetrating through the insulating layer and electrically connecting a section of the second electrode in the electrode layer to the second electric wire section in the bridge layer.

This configuration enables the electrode sections of the first electrode and the second electrode to have substantially the same size. Thus, this configuration reduces deviation in signal intensity caused due to variations of the size of the electrode sections when the scan direction is the X direction.

A touch panel according to a second aspect of the present disclosure referring to the first aspect may further include third electrodes and fourth electrodes successively and electrically independently arranged in each of the electrode layer and the bridge layer in a Y direction orthogonal to the X direction; and unit lattices C and unit lattices D alternately arranged one by one in the Y direction. Each of the third electrodes includes: a third electrode section disposed in the electrode layer in a corresponding one of the unit lattices C; a third electric wire section disposed in at least the bridge layer in a corresponding one of the unit lattices D and connecting the third electrode sections to each other in the Y direction; and a third connection section penetrating through the insulating layer and electrically connecting a section of the third electrode in the electrode layer to the third electric wire section in the bridge layer. Each of the fourth electrodes includes: a fourth electrode section disposed in the electrode layer in a corresponding one of the unit lattices D; a fourth electric wire section disposed in at least the bridge layer in a corresponding one of the unit lattices C and connecting the fourth electrode sections to each other in the Y direction; and a fourth connection section penetrating through the insulating layer and electrically connecting a section of the fourth electrode in the electrode layer to the fourth electric wire section in the bridge layer.

This configuration enables electrode sections of the first electrode and the second electrode to have substantially the same shape. Moreover, this configuration enables electrode sections of the third electrode and the fourth electrode to have substantially the same size. Thus, this configuration reduces deviation in signal intensity caused due to variations of the size of the electrode sections when the scan directions are the X direction and the Y direction.

In a touch panel according to a third aspect of the present disclosure referring to the second aspect, the first electrode section, the second electrode section, the third electrode section, and the fourth electrode section may have the same area in the unit lattices.

With this configuration, when the scan directions are plane directions defined by the X direction and the Y direction, deviation in signal intensity caused due to variations of the size of the electrode sections can be reduced.

In a touch panel according to a fourth aspect of the present disclosure referring to the second or third aspect, each of the first electrode section, the second electrode section, the third electrode section, and the fourth electrode section may include: triangle sections arranged in two of four triangular areas defined by diagonals in each of the unit lattices, the two triangular areas facing each other; and a joint section electrically connecting top corners of the triangle sections which face each other, wherein the first electric wire section may be connected to bottom corners of the triangle section in the first electrode section, the second electric wire section may be connected to bottom corners of the triangle section in the second electrode section, the third electric wire section may be connected to bottom corners of the triangle section in the third electrode section, and the fourth electric wire section may be connected to bottom corners of the triangle section in the fourth electrode section.

This configuration enables the electrode sections in each unit lattice to have the same size and the size of each electrode section to be increased. Thus, this configuration is very effective to increase the intensity of an electrical signal in all of the scan directions when the touch panel is used.

In a touch panel according to a fifth aspect of the present disclosure referring to any of the second to fourth aspects, the electrode layer may include a first electrode layer including the first electrode sections and the second electrode sections, and a second electrode layer including the third electrode sections and the fourth electrode sections, wherein one of the first electrode layer and the second electrode layer may be made of a conductive material which is transparent, and the other of the first electrode layer and the second electrode layer may be made of metal.

This configuration enables the electrical resistance of the overall touch panel to be reduced and a charging time of the electrode sections to be significantly reduced. Thus, this configuration is very effective to increase the responsiveness of the touch panel.

A touch panel according to a sixth aspect of the present disclosure referring to the fifth aspect may further include an additional insulating layer disposed between the first electrode layer and the second electrode layer, and a contact section which electrically connects the first electrode layer and the second electrode layer to each other.

This configuration enables the electrodes in the first electrode layer and the electrodes in the second electrode layer to be electrically connected. Thus, this configuration is very effective because the electrical resistance of the overall touch panel is reduced.

The touch panel of the present embodiment is applicable to input apparatuses for electronic products in a similar manner to known touch panels. In the touch panel of the present embodiment, an electrical signal is more intense than in the related art touch panel, and the electrical resistance of the overall electrodes can be reduced. Therefore, the touch panel of the present embodiment has better responsiveness than the related art touch panel. The touch panel of the present embodiment may be suitably used in particular for applications which have to have such excellent responsiveness.

The present disclosure contains subject matter related to that disclosed in Japanese Priority Patent Application JP 2017-197268 filed in the Japan Patent Office on Oct. 10, 2017, the entire contents of which are hereby incorporated by reference.

The present disclosure is not limited to the embodiments described above. Various modifications may be made within the scope of the claims. Embodiments obtained by accordingly combining the techniques disclosed in different embodiments are also within the technical scope of the present disclosure. Moreover, combining technical means disclosed in the embodiments can provide new technical feature.

What is claimed is:

1. A touch panel comprising:
an electrode layer, an insulating layer, and a bridge layer which are sequentially stacked on one another;
first electrodes and second electrodes successively and electrically independently arranged in each of the electrode layer and the bridge layer in an X direction; and
unit lattices A and unit lattices B alternately arranged one by one in the X direction, wherein
each of the first electrodes includes
a first electrode section disposed in the electrode layer in a corresponding one of the unit lattices A,
a first electric wire section disposed in at least the bridge layer in a corresponding one of the unit lattices B and connecting the first electrode sections to each other in the X direction, and
a first connection section penetrating through the insulating layer and electrically connecting a section of the first electrode in the electrode layer to the first electric wire section in the bridge layer, and
each of the second electrodes includes
a second electrode section disposed in the electrode layer in a corresponding one of the unit lattices B,
a second electric wire section disposed in at least the bridge layer in a corresponding one of the unit lattices A and connecting the second electrode sections to each other in the X direction, and
a second connection section penetrating through the insulating layer and electrically connecting a section of the second electrode in the electrode layer to the second electric wire section in the bridge layer.

2. The touch panel according to claim 1, further comprising:
third electrodes and fourth electrodes successively and electrically independently arranged in each of the electrode layer and the bridge layer in a Y direction orthogonal to the X direction; and
unit lattices C and unit lattices D alternately arranged one by one in the Y direction, wherein
each of the third electrodes includes
a third electrode section disposed in the electrode layer in a corresponding one of the unit lattices C,
a third electric wire section disposed in at least the bridge layer in a corresponding one of the unit lattices D and connecting the third electrode sections to each other in the Y direction, and
a third connection section penetrating through the insulating layer and electrically connecting a section of the third electrode in the electrode layer to the third electric wire section in the bridge layer, and
each of the fourth electrodes includes
a fourth electrode section disposed in the electrode layer in a corresponding one of the unit lattices D,
a fourth electric wire section disposed in at least the bridge layer in a corresponding one of the unit lattices C and connecting the fourth electrode sections to each other in the Y direction, and
a fourth connection section penetrating through the insulating layer and electrically connecting a section of the fourth electrode in the electrode layer to the fourth electric wire section in the bridge layer.

3. The touch panel according to claim 2, wherein
the first electrode section, the second electrode section, the third electrode section, and the fourth electrode section have the same area in the unit lattices.

4. The touch panel according to claim 2, wherein
each of the first electrode section, the second electrode section, the third electrode section, and the fourth electrode section includes:
triangle sections arranged in two of four triangular areas defined by diagonals in each of the unit lattices, the two triangular areas facing each other; and
a joint section electrically connecting top corners of the triangle sections which face each other, wherein
the first electric wire section is connected to bottom corners of the triangle section in the first electrode section,
the second electric wire section is connected to bottom corners of the triangle section in the second electrode section,
the third electric wire section is connected to bottom corners of the triangle section in the third electrode section, and
the fourth electric wire section is connected to bottom corners of the triangle section in the fourth electrode section.

5. The touch panel according to claim 2, wherein
the electrode layer includes
a first electrode layer including the first electrode sections and the second electrode sections, and
a second electrode layer including the third electrode sections and the fourth electrode sections,
one of the first electrode layer and the second electrode layer is made of a conductive material which is transparent and
the other of the first electrode layer and the second electrode layer is made of metal.

6. The touch panel according to claim 5, further comprising:
an additional insulating layer disposed between the first electrode layer and the second electrode layer, and
a contact section which electrically connects the first electrode layer and the second electrode layer to each other.
